(19) United States
(12) Patent Application Publication
(10) Pub. No.: US 2026/0364914 A1
(43) Pub. Date: Nov. 19, 2026

(54) Apparatus and Process for Forming a Tessellated Packaging Material

(71) Applicant: Rehex LLC, Los Angeles, CA (US)

(72) Inventor: Lucas Michael Todd, Los Angeles, CA (US)

(21) Appl. No.: 19/144,241

(22) PCT Filed: Dec. 29, 2023
(86) PCT No.: PCT/US2023/086446

§ 371 Date: Jun. 27, 2025

Related U.S. Application Data
(60) Provisional application No. 63/435,828, filed on Dec. 29, 2022.
(60) Provisional application No. 63/435,830, filed on Dec. 29, 2022.
(60) Provisional application No. 63/435,833, filed on Dec. 29, 2022.

(51) Int. Cl. B31D 5/00; B31F 1/10

(52) U.S. Cl. CPC B31D 5/006; B31F 1/10; B31D 2205/0023; B31D 2205/0047; B31D 2205/0058

(57) ABSTRACT

An apparatus comprising a rotary press roller die for forming a tessellated packaging material is provided. The roller die comprises a forming surface having a plurality of ridges extending circumferentially along the forming surface and spaced axially from each other. Every two adjacent ridges is separated by a valley. Each ridge has a ridgeline that zigzags in the circumferential direction alternating between a first angle α and a second angle p with respect to a plurality of longitudinal lines running parallel to an axis of the roller die. The longitudinal lines are spaced circumferentially from each other. Each valley has a valley line that zigzags generally parallel to the ridgelines in the circumferential direction such that the forming surface comprises a plurality of parallelogrammatic facets each having two vertices at angle a and two vertices at angle β.

### BACKGROUND OF THE INVENTION

Consumer goods are typically shipped in boxes containing the goods and a protective packaging material. The protective material can serve as either a cushioning material that protects fragile items from shocks and vibrations that occur during shipping or as a void fill material that protects products by filling excess space in the shipping box to prevent product movement and breakage. For example, commonly used protective packaging materials include bubble wrap, air bags, crumpled kraft paper, expanded polystyrene foam, polyethylene foam, molded pulp, packing peanuts, honeycomb wrap, mycelium packaging, starch-based loose fill, and shredded paper. However, these materials suffer from being either too expensive, unsightly, inadequate at protecting underlying goods, environmentally unfriendly, too bulky for storage, unsuitable for humid environments, and/or difficult to dispose of.

Therefore, in the packing and shipping industry, there is an increasing demand for an adaptable, sustainable, and protective packing material that is inexpensive and eliminates the reliance on environmentally-harmful processes.

### SUMMARY OF THE INVENTION

In accordance with one embodiment of the present invention, an apparatus is provided to form a packaging material that produces less waste, provides strong protection to goods, is sustainable, and is aesthetically pleasing. The material can serve both the purposes of void fill and cushioning for packaged goods.

In one aspect, an apparatus for making a tessellated packaging material is provided. The apparatus comprises a frame, a first axle attached to the frame, a second axle parallel to the first axle and attached to the frame, a first rotary press roller die disposed along the first axle and a second rotary press roller die disposed along the second axle. The first roller die comprises a forming surface having a plurality of ridges extending circumferentially along the forming surface and spaced axially from each other. Every two adjacent ridges are separated by a valley. Each ridge has a ridgeline that zigzags in the circumferential direction, alternating between a first angle α and a second angle β with respect to a plurality of longitudinal lines running parallel to an axis of the roller die. The longitudinal lines are spaced circumferentially from each other. Each valley has a valley line that zigzags generally parallel to the ridgelines in the circumferential direction such that the forming surface comprises a plurality of parallelogrammatic facets. Each of the facets has two vertices at angle α and two vertices at angle β.

The second roller die has a forming surface complimentary to the forming surface of the first roller die. The first and second roller dies are aligned such that a plurality of valleys on the second roller die intermesh with the ridges of the first rotary die. The first roller die is configured to rotate around its axis in a first direction and the second roller die is configured to rotate around its axis in the opposite direction.

In another aspect, a rotary press roller die for forming a tessellated packaging material is provided. The roller die comprises a forming surface having a plurality of ridges extending circumferentially along the forming surface and spaced axially from each other. Every two adjacent ridges are separated by a valley. Each ridge has a ridgeline that zigzags in the circumferential direction alternating between a first angle α and a second angle β with respect to a plurality of longitudinal lines running parallel to an axis of the roller die. The longitudinal lines are spaced circumferentially from each other. Each valley has a valley line that zigzags generally parallel to the ridgelines in the circumferential direction such that the forming surface comprises a plurality of parallelogrammatic facets. Each facet has two vertices at angle α and two vertices at angle β.

In accordance with another embodiment of the present invention, a process is provided to form the packaging material. In one aspect, the process comprises feeding a sheet of creasable material between a first rotary press roller die and a second rotary press roller die to form a tessellated packaging material.

The tessellated packaging material comprises a tessellated sheet having a plurality of parallel straight fold lines and a plurality of zigzagging fold lines extending across the plurality of straight fold lines. The zigzagging fold lines alternate directions at each straight fold line between an angle α and an angle β with respect to the straight fold lines such that the straight and zigzagging fold lines define a plurality of parallelograms each having two vertices at angle α and two vertices at angle β. Each zigzagging fold line defines either a ridge or a valley. The ridges alternate with the valleys along each straight fold line.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 is a top view of a packaging material in accordance with the present disclosure;

FIG. 2 is a perspective view of a packaging material in accordance with the present disclosure;

FIG. 3 is a perspective view of a partially compressed packaging material in accordance with the present disclosure;

FIG. 4 is a perspective view of a package in accordance with the present disclosure;

FIG. 5 is a perspective view of a packaging material in accordance with the present disclosure;

FIG. 6 is a perspective view of an item and a packaging material in accordance with the present disclosure;

FIG. 7 is a section view showing selected components of an apparatus for producing a packaging material in accordance with the present disclosure;

FIG. 8 is a right-side view of drive mechanisms on an apparatus for producing a packaging material in accordance with the present disclosure;

FIG. 9 is a left-side view of drive mechanisms on an apparatus for producing a packaging material in accordance with the present disclosure;

FIG. 10 is a top view of an apparatus for producing a packaging material in accordance with the present disclosure;

FIG. 11 is a side view of an apparatus for producing a packaging material in accordance with the present disclosure;

FIG. 12 is a perspective view of an apparatus for producing a packaging material in accordance with the present disclosure;

FIG. 13 is a perspective view of a rotary press roller die in accordance with the present disclosure;

FIG. 14 is a perspective view of a pair of rotary press roller dies and a packaging material in accordance with the present disclosure; and

FIG. 15 is a perspective view of a pair of rotary press roller dies in accordance with one embodiment of the present disclosure.

### DETAILED DESCRIPTION

It is to be understood by one of ordinary skill in the art that the present discussion is a description of exemplary embodiments only and is not intended as limiting the broader aspects of the present invention.

Generally speaking, the present disclosure is directed to a packaging material comprising a tessellated sheet, a method for making the packaging material, and an apparatus that can be used to make the material.

The packaging material comprises a tessellated sheet which is based on a type of Miura-ori fold pattern. By forming the material with such a fold pattern, a sheet of paper can be formed into a metamaterial that is adaptable to a variety of configurations and can be compressed for efficient storage. The shape of the material provides it with properties which allow it to be used as either a void fill or cushioning packaging material for protecting items shipped in packages. Advantageously, the material can be formed from recycled paper, making it a sustainable packaging solution.

One advantage of the material over conventional protective packaging materials is that the tessellated sheet can be compressed for storage and easily expanded for use. For example, the volume of the packaging material in a partially expanded state can be about 10 or more times greater than the volume of the material in its compressed form. In some embodiments, for example, the volume of the material in a partially expanded state can be about 16 or more times more than the volume of the material in its compressed state. Conveniently, the tessellated sheets can be compressed and stacked to store and transport efficiently in boxes.

As used herein, the volume of the material is calculated by multiplying the length of the material in a given state by the width of the material in that state by the height from the top of the ridges of the material to the bottom of the valleys of the material in that state. Additionally, as used herein, the compressed state is defined as the state of the material when fully folded along the fold lines. In contrast, the fully expanded state is defined by the state of the material when pulled completely flat, having the same dimensions as a non-folded sheet. When the sheet is neither compressed nor fully expanded, it is in a partially expanded state. The packaging material is most useful as a protective packaging material in its partially expanded state as it has the properties of a metamaterial with an increased volume.

Additionally, the packaging material can be made from paper or paperboard, which makes it easily recyclable. In some embodiments, the packaging material itself is made from recycled paper. Paper is a biodegradable, compostable, renewable, and recyclable resource. Additionally, unlike plastics, minimal processing is needed to recycle paper. For these reasons, the packaging material described herein is more sustainable than those made from plastics such as polyethylene and polystyrene.

Further, due to the pattern of folds in the packaging material, the material possesses a high strength-to-weight ratio that provides excellent protection to goods. In this regard, less material is needed to protect products compared to many conventional protective packaging materials. Furthermore, since the packaging material is in the form of a sheet, graphics can be printed onto the material, such as brand logos and colors.

Advantageously, the packaging sheet can be used in multiple ways during packaging. For example, it can be used to wrap around individual products, such as fragile items, to cushion and protect them against impacts. The packaging material can also be used as a void fill material to fill empty space within a box in order to prevent the contents from moving around in transit and to prevent the box from collapsing under the weight of nearby packages. The packaging material can also be used to prevent damage to boxes by placing the material on the edges of the interior of the box, providing edge crush protection to the corners and sides of the box.

The packaging material achieves its excellent protective properties due to its tessellated folding structure. The sheet comprises a plurality of unit cells defined by parallelogrammatic faces that allow the sheet to function as a metamaterial having mechanical properties much improved from the mechanical properties of the base material (e.g., a sheet of paper). The fold pattern described herein allows the packaging material to have a high ratio of volume of the metamaterial (the partially expanded sheet) to the volume of the base material, which is the unfolded sheet. Additionally, the folding structure provides the packaging material with enough degrees of freedom to enable it to adapt to various shapes and be wrapped around products. Further, the packaging material can be produced from a sheet in a tessellated pattern without producing any waste from off-cuts.

The fold structure is based on the Miura-ori fold pattern, which has an origin in origami techniques. While the Miura-ori fold pattern is known from origami and other industries such as folded solar panels, no highly efficient means for folding a sheet with a Miura-ori fold pattern have existed. For example, the sheets are typically either folded by hand or press molded. Neither method allows for continuous production of tessellated sheets. As described herein, the present inventor has discovered an efficient process for continuously producing a packaging material comprising a tessellated sheet folded in a Miura-ori type of pattern.

The packaging material is described in further detail below with reference to FIGS. 1-6.

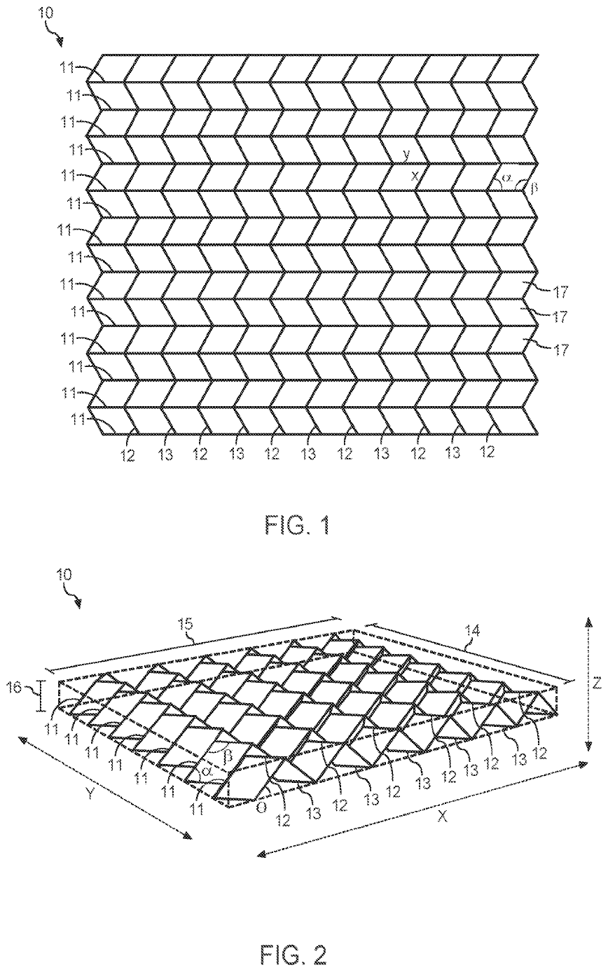

One embodiment of the packaging material is illustrated by FIGS. 1 and 2. As shown, the packaging material 10 comprises a tessellated sheet having plurality of straight fold lines 11 running parallel to each other in one direction of the sheet and a plurality of zigzagging fold lines 12 and 13 alternating between ridges 12 and valleys 13. The ridges 12 and valleys 13 also run parallel to each other in a direction generally across the straight fold lines 11. The fold lines 11, 12, and 13 form a plurality of parallelograms 17. Each parallelogram 17 has two vertices at angle α and two vertices at angle β, as illustrated by FIGS. 1 and 2. Angle α is an acute angle formed at the intersection between a ridge fold 12 or valley fold 13 and one of the straight fold lines 11. Angle β is an obtuse angle supplementary to angle α so that α+β=180°. Following one of either the valley folds 13 or the ridge folds 12 from one end of the sheet to the other, the zigzagging fold will change directions at each straight fold line 11 such that it alternates between forming an angle α with every other straight fold line and an angle β at every other straight fold line when measuring the angle from the same side of the zigzagging fold line.

In some embodiments, angle α is from about 50 to about 85 degrees, preferably from about 55 to about 75 degrees. In some embodiments, the distance between the straight fold lines is from about 1 cm to about 10 cm when measured along the zigzagging fold lines (length x). In some embodiments, the distance between a ridge line to the adjacent valley line (length y) is from about 1 cm to about 10 cm when measured along a straight fold line. In some embodiments, y is greater than x. For example, the ratio between y and x may be from about 3:1 to about 1:1. However, in other embodiments, the ratio may be from about 1:3 to about 1:1.

In some embodiments, the tessellated sheet is formed from a single square or rectangular sheet of paper. In some embodiments, the entire sheet comprises only the plurality of parallelograms, meaning that there are no other shapes formed by the fold lines, including at the edges of the sheet. Preferably, other than optional perforations, the sheet does not comprise any slits or other cuts that aid in shaping the sheet.

The sheet may be a section cut from a roll of recycled kraft paper.

However, the sheet can be made from any suitable foldable material, which can include non-recycled paper, paperboard, or a sheet which includes synthetic fibers such as those made from nylon or other synthetic polymers. However, the sheet is preferably made from recycled paper due to cost and sustainability advantages. For example, in some embodiments, cellulosic fibers constitute more than 95 wt. % of the total fiber content in the sheet. In some embodiments, cellulosic fibers obtained from a kraft process constitute 100 wt. % of the fibers in the sheet. In some embodiments, the sheet is untreated by coating agents, glues, stiffening agents, or other treating agents.

The shape of the packaging material 10 is better illustrated by FIG. 2. As shown, the packaging material 10 has a length 14, a width 15, and a height 16. FIG. 2 shows the packaging material and directions x, y, and z. The length 14 is defined in the y direction which runs perpendicular to the straight fold lines 11. The width 15 is defined in the x direction, which runs parallel to the straight fold lines 11. The height 16 is defined as the distance in the z direction from the bottom of the valleys 13 to the top of the ridges 12. The angle between the straight fold lines 11 on a ridge 12 with respect to the xy plane is shown as angle θ in FIG. 2. Angle θ varies as the packaging material is expanded and compressed. For example, when fully expanded, angle θ is 0° and when fully compressed, θ is 90°.

The volume of the packaging material can be calculated by multiplying the length 14 by the width 15 by the height 16. The volume of the material is maximized when θ is 45°. As explained above, the folding pattern of the packaging material creates a large ratio between the maximum volume of the material and the fully compressed volume. For example, the ratio can be about 10 or more, in some embodiments about 13 or more, and in some embodiments, about 16 or more.

Each fold also has a width, which is determined by the thickness of the material being folded and the sharpness of the fold. The width is defined as the distance from one side of the crease line to the other side of the crease line. For example, it can be measured as the distance between the points on either side of a fully folded line where the curved portion of the fold line meets the flat surface of the adjacent flat section. Thicker materials and less sharp (more rounded) folds will have a wider width. In some embodiments, the width along the zigzagging fold lines 12 and 13 is equivalent to the width of the straight fold lines 11.

The packaging material may have any width suitable for a particular packaging purpose. While there is no limitation on the width or number of ridges on the packaging material, in some embodiments, the packaging material comprises from about 2 to about 20 ridges along its width. In some embodiments, the packaging material comprises an even number of ridges along its width. In other embodiments, the packaging material comprises an odd number of ridges along its width. The ridges may be made larger or smaller as desired. Similarly, while there is no limitation on the length of the packaging material and it can extend essentially continuously along its length, in some embodiments, the length of the packaging material when fully expanded, which is equivalent to the length of the sheet prior to folding, can be from about 10 cm to about 500 cm, in some embodiments, from about 20 cm to about 200 cm, and in some embodiments, from about 30 cm to about 100 cm.

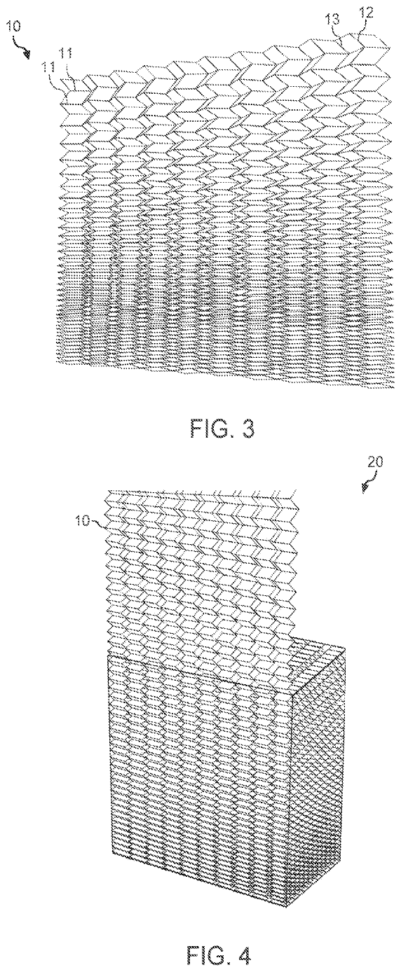

FIG. 3 shows an embodiment of the packaging material 10 where the bottom portion as viewed in the drawing is compressed and the top portion is partially expanded. As shown, the material significantly shortens along its length when compressed.

FIG. 4 shows an embodiment of a package 20 comprising a plurality of packaging materials 10. To maximize storage efficiency, the packaging materials 10 are compressed when stored and transported. Conveniently, when compressed, they can be stacked with one another and placed in a box, as shown in FIG. 4. This is one of the major advantages of the material compared to conventional packaging materials, as the volume of the packaging material when in use is much larger than the volume of the packaging material when stored.

When stored in a box as shown in FIG. 4, each individual packaging material 10 may have a relatively long length such that each compressed material takes up the majority of the height of the box. In such an embodiment, the material may be perforated periodically along its width such that smaller sheets suitable for use in a protected package can be easily broken off from the longer sheet. Alternatively, each individual packaging material 10 may have a relatively short length suitable for use as is. In such an embodiment, the packaging materials 10 may be stacked vertically and horizontally within the box 20.

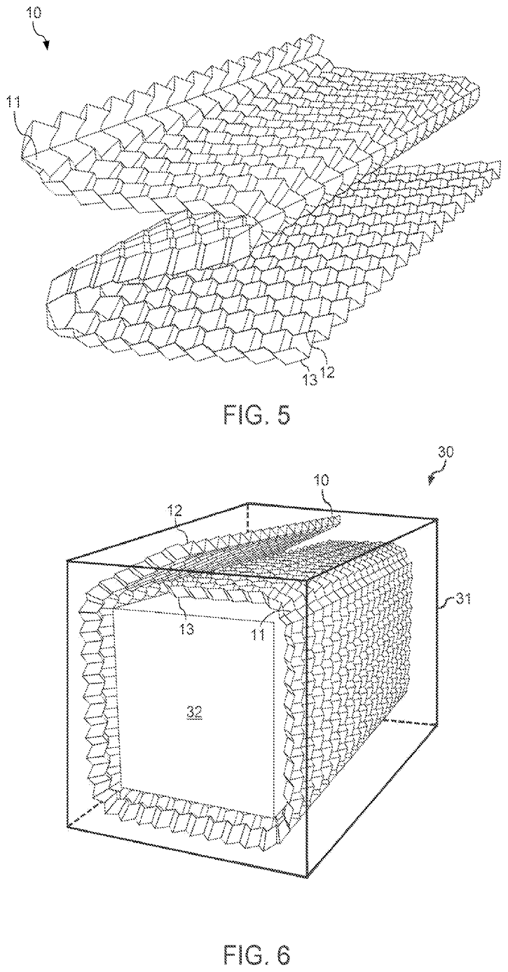

FIGS. 5 and 6 show how the packaging material 10 can function as an adaptable metamaterial. For example, as shown in FIG. 5, the packaging material can be readily bent along its width by bending along one or more of the straight fold lines 11. As such, the packaging material can be bent over itself to form an S-like shape, as shown in FIG. 5, or can be formed into a loop as shown in FIG. 6. When bent in a manner similar to that shown in FIG. 5, the packaging material is particularly effective as a void filling material, taking up maximal volume in a package. In addition to the configurations shown by FIGS. 5 and 6, the material can be bent or twisted in many different ways, as desired. The general idea is that the packaging material serves as a metamaterial which can take a variety of shapes due to its folding pattern.

FIG. 6 shows an embodiment of a package 30 containing an item 32, a packaging material 10, and a container 31 (e.g., a box). The packaging material is looped around the item 32 to protect it from impacts that may occur in transit. The packaging material also helps prevent the item from shifting within the container 31.

In some embodiments, the packaging material can be looped as shown in FIG. 6 and attached to itself to maintain the loop configuration. For example, one end of the tessellated sheet may be taped, glued, or fastened by any other suitable means to the other end of the tessellated sheet. Further, the material may be looped multiple times around an item in a spiral manner. Alternatively, the packaging material can be taped directly to the item. The item is not limited and can be any consumer good typically shipped in a container with a protective packaging material.

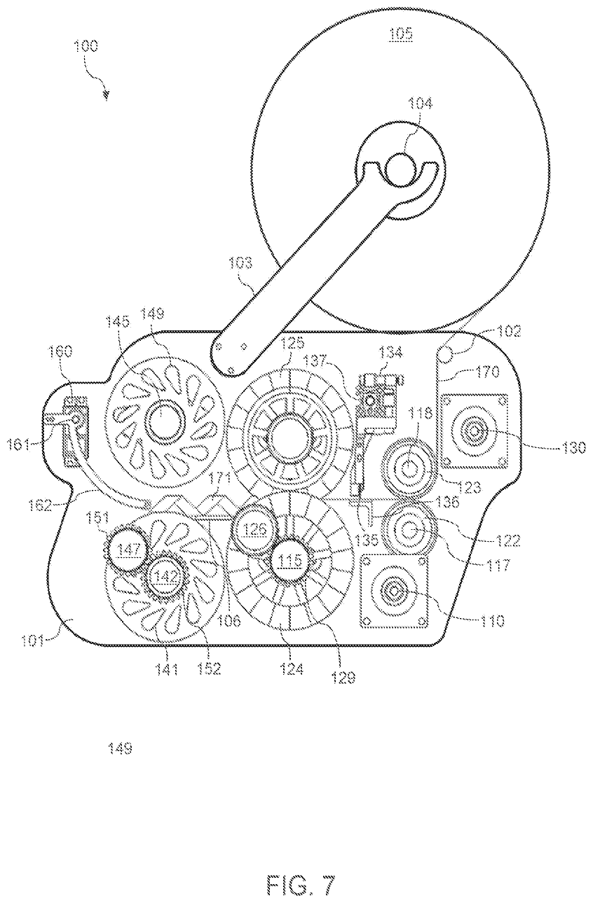

FIGS. 7-15 illustrate an apparatus suitable for forming the packaging material described herein. The apparatus is advantageous because it is capable of forming a tessellated sheet quickly and continuously through the use of a pair of rotary press roller dies having a surface shape that corresponds to the folds of the packaging material. While the apparatus provides one way to form a sheet between a pair of roller dies, it should be appreciated that a person skilled in the art can envision other configurations of the apparatus.

FIG. 7 shows select components of one embodiment of the apparatus and the path that a sheet of formable material (e.g., paper) takes from a supply roll to a folded tessellated sheet. As shown, the apparatus comprises a frame 101, which can be formed from any suitable rigid material, such as steel. Attached to the frame 101 is an arm 103 that can hold a dowel 104 containing a supply roll 105. The supply roll is preferably a roll of recycled kraft paper but can be any material suitable for forming a tessellated folded sheet.

A single layer of the material 170 is shown passing through the apparatus 100. After being fed away from the supply roll 105, the sheet 170 passes over a tensioning shaft 102. The tensioning shaft 102 can be made from any suitable material such as metal or a rigid polymer. The shaft runs between a first side of the frame 101 to a second side of the frame 101. The tensioning shaft 102 helps keep the sheet 170 aligned and straight as it enters a pair of feed rollers comprising a top feed roller 123 and a bottom feed roller 122. The pair of feed rollers are configured to rotate in opposite directions so as to cause the sheet 170 to move toward a pair of rotary press roller dies comprising a top roller die 125 and a bottom roller die 124.

The top feed roller 123 is attached to an axle 118 which runs between a first side of the frame 101 and a second side of the frame 101. From the view shown in FIG. 7, the top feed roller 123 is configured to rotate clockwise with axle 118. The bottom feed roller 122 is attached to an axle 117 running parallel to axle 118 also between the first side of the frame 101 and the second side of the frame 101. From the viewpoint shown in FIG. 7, the bottom feed roller 122 is configured to rotate counterclockwise. The gap between the top feed roller 123 and the bottom feed roller 122 can be adjusted to the thickness of the sheet 170.

After passing through the feed rollers 122 and 123, the sheet 170 passes through the pair of rotary press roller dies 124 and 125. The roller dies have intermeshing surfaces which are shaped to form the tessellated fold pattern of the packaging material as the sheet 170 passes through them. The surfaces of the dies are shown in greater detail below. The top roller die 125 is attached to an axle 116 running from the first side of the frame 101 to the second side of the frame 101 and the bottom roller die 124 is attached to an axle 115 running parallel to the axle 116, also between the first and second sides of the frame 101. The top and bottom roller dies 125 and 124 are spaced from each other such that their surface patterns intermesh with one another to apply sufficient folding pressure to the sheet of material 170 to form creases in the material corresponding to the fold lines of the tessellated sheet. The top roller die 125 is configured to rotate in the same direction as the top feed roller 123 and the bottom roller die 124 is configured to rotate in the same direction as the bottom feed roller 122. Advantageously, the apparatus can comprise only one set of rotary press roller dies. In this regard, the creases in the tessellated sheet can be formed using only one set of roller dies (in addition to the other roller sets which are not dies).

After passing through the pair of rotary press roller dies 124 and 125, the tessellated sheet 171 passes over a guide rail 106 which runs from the first side of the frame 101 to the second side of the frame 101 and helps keep the tessellated sheet in line as it is fed toward a pair of outfeed rollers comprising a top outfeed roller 149 and a bottom outfeed roller 141.

The top outfeed roller 149 is attached to an axle 145 that extends from the first side to the second side of frame 101. The bottom outfeed roller 141 is attached to an axle 142 that runs parallel to axle 145 and also extends from the first side to the second side of frame 101. The top outfeed roller 149 is configured to rotate in the same direction as the top feed roller 123 and top roller die 125.

The bottom outfeed roller is configured to rotate in the same direction as the bottom feed roller 122 and the bottom roller die 124. There is a gap between the surfaces of the top outfeed roller 145 and the bottom outfeed roller 141. The gap is typically wider than the gap between the pair of feed rollers 122 and 123, as the sheet 170 exits the pair of roller dies as a tessellated sheet 171 having a height 16 greater than the thickness of the unfolded sheet 170. As such, the gap between the outfeed rollers 141 and 149 is preferably slightly less than the height 16 of the tessellated sheet 171 when compressed. The outfeed rollers are preferably formed from a soft and relatively flexible and forgiving material that does not require precise tolerance to allow material to pass through.

The apparatus 100 further comprises a least one outfeed control arm 162. The outfeed control arm 162 is movable between a first (lower) position in which it extends into the gap between the top outfeed roller 149 and the bottom outfeed roller 141 and a second (upper) position in which it is rotated away from the gap and allows the tessellated sheet 171 to pass through. The outfeed control arm 162 is mounted to an axle 161 extending from the first side to the second side of the frame 101. In some embodiments, multiple outfeed control arms 162 are mounted to the same axle 161 and are configured to move synchronously with each other.

The purpose of the outfeed control arm(s) 162 is to block the first edge of the tessellated sheet 171 after it passes through the pair of roller dies 124 and 125. As the leading edge is blocked, the feed rollers 122 and 123 and roller dies 124 and 125 can continue to rotate, pushing more of the tessellated sheet 171 into the outfeed control arms 162, causing the tessellated sheet 171 to compress against the blocked portion and deepen the folds at the fold lines.

Once the fold lines are deepened, the tessellated sheet 171 will contact the outfeed rollers 149 and 141 as the height of the sheet 171 increases. The outfeed control arm(s) 162 can then be rotated outward and the outfeed rollers 141 and 149 can be rotated to eject the tessellated sheet 171 from the apparatus 100. The outfeed control arms 162 can be actuated by a motor 160 which rotates the arm(s) 162 around the axle 161. The axle can be fixed with the arms rotating around the axle or the axle 161 can rotate with the arms. In some embodiments, the motor 160 is a servo motor, but any motor capable of causing the arm(s) to rotate between a first and second position can be used.

The apparatus 100 further comprises a cutting mechanism 134 for cutting the sheet 170 between the feed rollers 122 and 123 and the roller dies 124 and 125. The cutting mechanism 134 comprises a blade 135 (e.g., a rotary blade) which cuts across the width of the sheet 170 in the direction parallel to axles 117 and 118. The cutting mechanism 134 slides across the width of the apparatus 100 along a guide rail 137 that extends from the first side to the second side of the frame 101. To provide support under the sheet for cutting against, there may be a cutting support rail 136 extending from the first side to the second side of the frame 101. While the cutting mechanism described above is one example of a suitable cutting mechanism, it should be understood that the cutting mechanism is not limited to this example can be any suitable cutting mechanism such as a guillotine cutting mechanism, a reciprocating cutting mechanism, or the like.

As shown in FIG. 7, the apparatus further comprises a motor 110 for driving the feed rollers 122 and 123 and the rotary press roller dies 124 and 125 and a motor 130 for driving the cutting mechanism 134 as it travels along the guide rail 137. The drive systems are described more fully below.

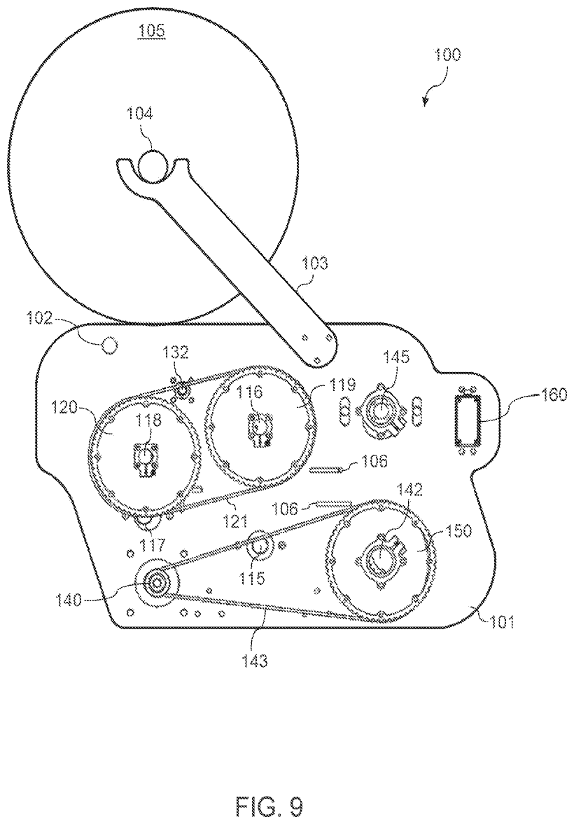

Also shown in FIG. 7 are a reverse gear 151 and a reverse gear 126. Reverse gear 151 is used to facilitate a synchronous counter-rotation between the top outfeed roller 149 and the bottom outfeed roller 141 using the same motor 140 (shown in FIG. 9). Reverse gear 151 is attached to a cantilevered axle 147 that runs from one side of the frame 101 to the reverse gear 151. Reverse gear 151 has teeth that intermesh with the teeth of a gear 152 attached to axle 142. As such, when the bottom outfeed roller 141 rotates in one direction, the reverse gear 151 rotates in the opposite direction. The top outfeed roller 149 is then driven by the reverse gear 151.

Reverse gear 126 has teeth that intermesh with the teeth of a gear 129 attached to axle 115. As such, when the bottom roller die 124 rotates in one direction, reverse gear 126 rotates in the opposite direction. Top roller die 125 is then driven by the rotation of reverse gear 126.

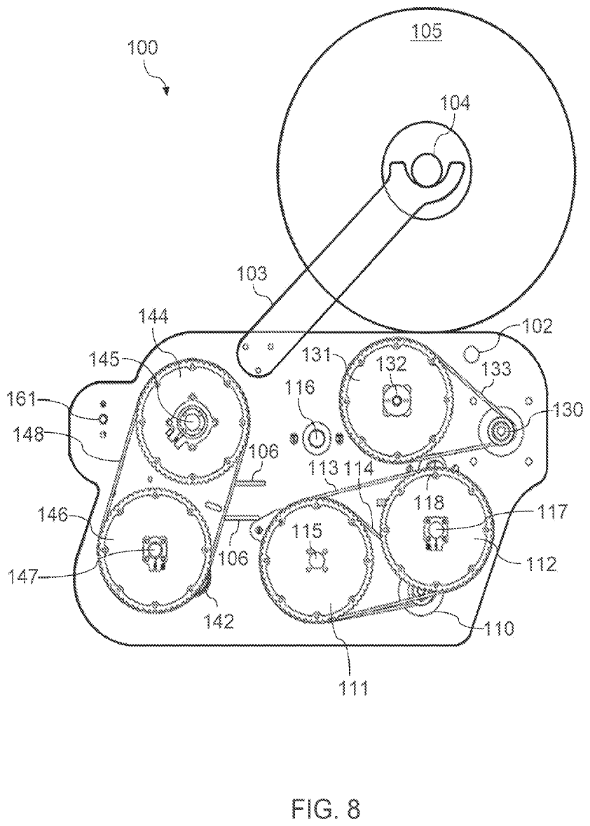

FIG. 8 shows the apparatus when viewed from the right side. As shown, motor 110 is configured to drive a pulley 111 attached to axle 115 via a drive belt 114 running over the pulley 111 and the motor 110. A second drive belt 113 runs over the pulley 111 and another pulley 112 attached to axle 117. As such, when the motor causes pulley 111 to rotate, pulley 112 is rotated synchronously. In this manner, the bottom roller die 124 and the bottom feed roller 122, which are attached to axles 115 and 117, respectively, are driven synchronously. It should be understood that wherever belt and pulley type drive mechanisms are described throughout this disclosure, other drive mechanisms can be employed to accomplish the same result. For example, gears can be used as an alternative to the belt and pulley systems described herein.

Also shown in FIG. 8 is a pulley 131 attached to axle 132. A drive belt 133 runs over the pulley 131 and motor 130. As pulley 131 is rotated, the rotational force on shaft 132 is used to slide cutting assembly 134 along the guide rail 137. This conversion from rotation of the axle to linear motion of the cutting assembly can be achieved by means well-known in the art, such as by the use of a leadscrew or a ball screw.

Additionally, as shown in FIG. 8, the apparatus comprises two more pulleys 144 and 146, which are attached to axles 145 and 147, respectively. A drive belt 148 runs over pulleys 144 and 146. As such, when reverse gear 151 is caused to rotate by gear 152 attached to axle 142 along with the bottom outfeed roller 141, top outfeed roller 149 is driven synchronously with bottom outfeed roller 141 by belt 148.

FIG. 9 shows the apparatus when viewed from the left side. As shown, the apparatus comprises a pulley 150 attached to axle 142. A drive belt 143 runs over pulley 150 and a motor 140. Motor 140 is configured to drive the outfeed rollers 141 and 149. For example, motor 140 drives the drive belt 143, which rotates pulley 150 and therefore the bottom outfeed roller 141, as both are attached to axle 142. As explained above, this also causes top outfeed roller 149 to counter-rotate with respect to bottom outfeed roller 141 through the motion of reverse gear 147, pulleys 144 and 146, and drive belt 148.

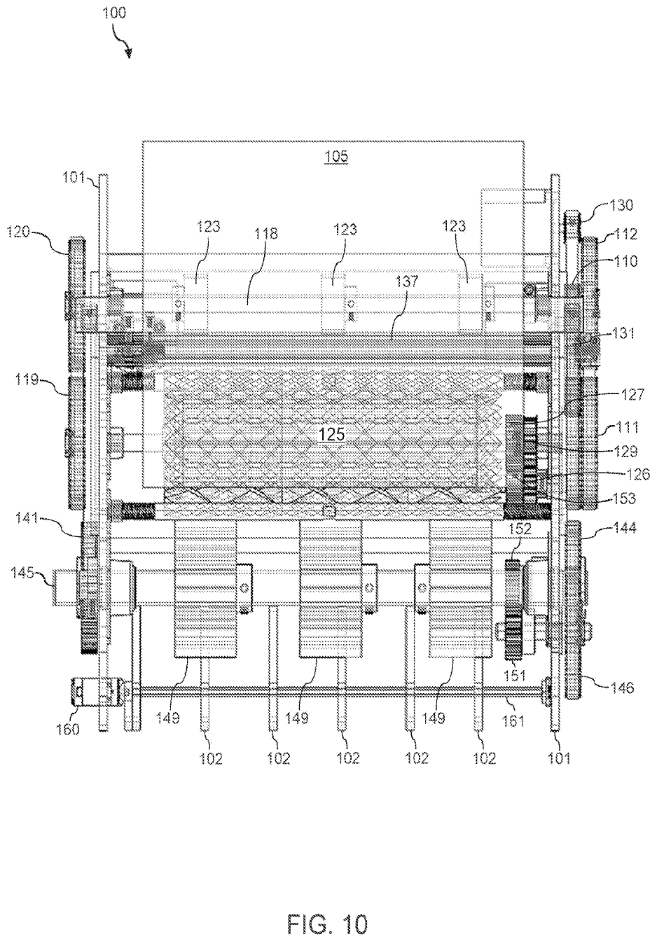

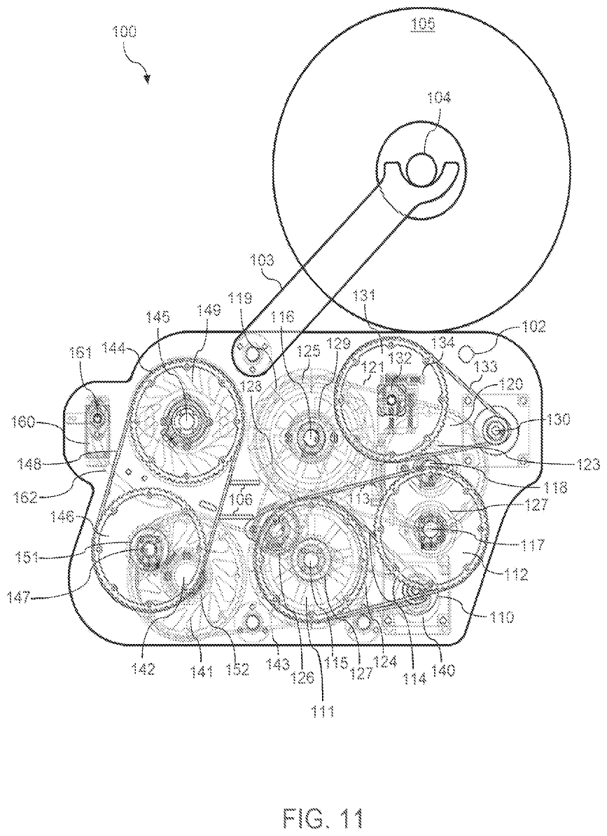

Also shown in FIG. 9 are pulleys 119 and 120, which are attached to axles 116 and 118, respectively, and are part of the feed roller and roller die drive system. Belt 121 runs over pulleys 119 and 120. Therefore, as motor 110 drives the bottom roller die 124 and the bottom feed roller 122 through belts 113 and 114 and pulleys 111 and 112, reverse gear 126 is counter-rotated with respect to gear 129 and the bottom roller die 124. Reverse gear 126 then drives a gear 129 (shown in FIGS. 10 and 11) attached to axle 116. This in turn drives the top roller die 125 and pulley 119, which are also attached to axle 116. Through belt 121, pulley 120 is also rotated, which in turn causes top feed roller 123 to rotate as it is also attached to axle 118. As such, both the top and bottom feed rollers 123 and 122, and the top and bottom roller dies 125 and 124 are all configured to rotate synchronously from the driving force from motor 110. The top feed roller 123 rotates in the same direction as top roller die 125 and the bottom feed roller 122 rotates in the same direction as bottom roller die 124, which is opposite to the direction of the top rollers.

FIGS. 10-12 show different views of the apparatus 100. FIG. 10 shows a top view of apparatus 100 in which the spatial relationship between the rollers, pulleys, gears, and outfeed control arms can be better viewed in relation to the frame 101. For example, it can be seen that pulley 111 can comprise either one wide pulley or two connected wheels side by side. An outer half of pulley 111 is in line with pulley 112 and an inner half of pulley 111 is in line with motor 110.

FIG. 10 also shows the intermeshing of reverse gear 151 and gear 152, which sit inside frame 101 and are part of the outfeed roller drive system.

Similarly, FIG. 10 shows the intermeshing relationship between reverse gear 126 and gear 129, which also sit inside of frame 101. A pulley 153 sits adjacent to reverse gear 126 on the same axle such that it rotates in sync with reverse gear 126. Another pulley 127 is attached to axle 116. A drive belt 128 (shown in FIG. 11) runs over pulleys 153 and 127 in order to drive the various components attached to axle 116.

FIG. 10 also shows that the top feed roller 123 can comprise multiple roller wheels spaced along axle 118. For example, in the embodiment shown in FIG. 10, three wheels which make up the top feed roller 123 are spaced along axle 118. Similarly, bottom feed roller 122 can comprise multiple roller wheels spaced along axle 117, which preferably line up with the roller wheels of the top feed roller 123.

FIG. 10 similarly shows that the top outfeed roller 149 can comprise multiple roller wheels spaced along axle 145. For example, in the embodiment shown in FIG. 10, three wheels which make up the top outfeed roller 149 are spaced along axle 145. Similarly, bottom outfeed roller 141 can comprise multiple roller wheels spaced along axle 142, which preferably line up with the roller wheels of the top outfeed roller 149.

FIG. 10 also shows that the at least one outfeed control arm 162 can comprise multiple outfeed control arms spaced along axle 161. For example, in the embodiment shown in FIG. 10, five outfeed control arms 162 are spaced along axle 161.

FIG. 11 shows a side view of apparatus 100 in which nearly all components are shown. Notably, in FIG. 11, drive belt 128 can be seen, which runs over pulleys 127 and 153, which are part of the drive system for the feed rollers and roller dies and facilitate their counter-rotation, as explained above.

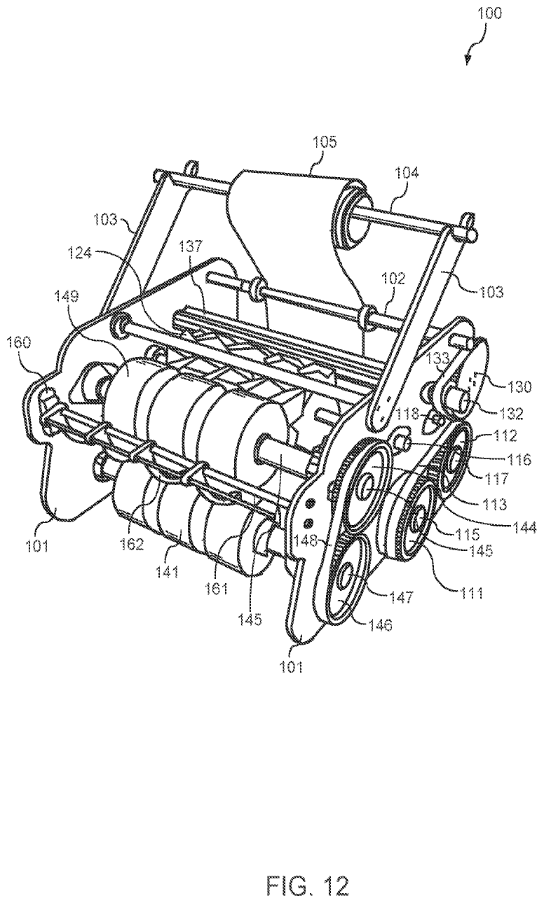

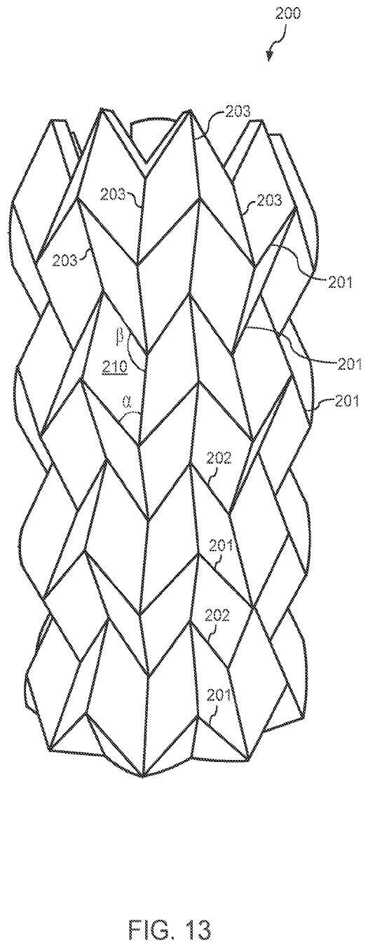

FIG. 12 shows a perspective view of the apparatus 100 and provides a better spatial illustration of many of the components and a good overview of the apparatus 100.

An embodiment of a rotary press roller die 200 is illustrated in FIG. 13. The roller die 200 comprises a forming surface with a plurality of ridges 201 extending circumferentially around the roller die 200. The forming surface also comprises a plurality of valleys 202 between the ridges 201. The valleys also extend around the circumference of the roller die 200. Both the ridges 201 and valleys 202 zigzag by alternating directions at each of a plurality of straight longitudinal lines 203 which extend in an axial direction. The zigzagging ridge lines 201 and valley lines 202 alternate between forming an angle α and an angle β with the longitudinal lines 203. As such, the forming surface of the roller die 200 comprises a plurality of parallelogrammatic facets 210, each having two vertices at angle α and two vertices at angle β. The ridge lines 201 preferably run parallel to the valley lines 202. Angles α and β, as well as the distance between the ridges, valleys, and straight longitudinal lines can correspond to same parameters described above with respect to the packaging material.

As used herein, a parallelogrammatic facet means a portion of the forming surface bounded by a ridge line 201, a valley line 202, and two adjacent longitudinal lines 203. The parallelogrammatic facet 210 is generally in the shape of a parallelogram but does not necessarily have straight edges. For example, since the roller die is generally cylindrical in shape, the edges of the parallelogrammatic facets may be curved. In some embodiments, the shape of the edges of the ridge lines 201 and the valley lines 202 of the roller die 200 is an involute curve in a plane perpendicular to the axis of the roller die 200.

The size of the roller die 200 may be modified as desired. In some embodiments, the roller die 200 has from 2 to 20 ridges. In some embodiments, the roller die has an even number of ridges along its width. In other embodiments, the roller die has an odd number of ridges along its width. However, as explained above with respect to the width of the packaging material, the roller die can be any suitable width and is not limited. If the dies are used to form perforations, the circumference of at least one of the roller dies used to punch the perforations can be selected based on the intended length between perforated sections.

The rotary press roller dies may be formed from any rigid material that can be formed into the shape described above and shown in FIGS. 13-15. For example, it can be formed from a machined metal, or an injection molded, cast, or 3D printed thermoplastic polymer or other formable polymer.

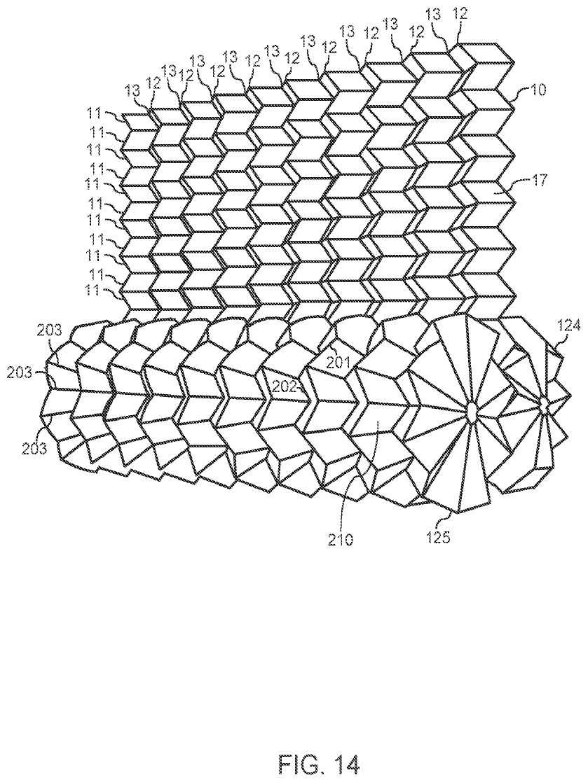

FIG. 14 shows a packaging material 10 exiting a pair or rotary press roller dies 124 and 125. As shown, the tessellated pattern on the packaging material 10 corresponds to the plurality of ridges 201 and valleys 202 that extend around the roller dies 124 and 125. Thus, the parallelograms 17 have the same shape as the parallelogrammatic facets 210 on the roller dies 124 and 125.

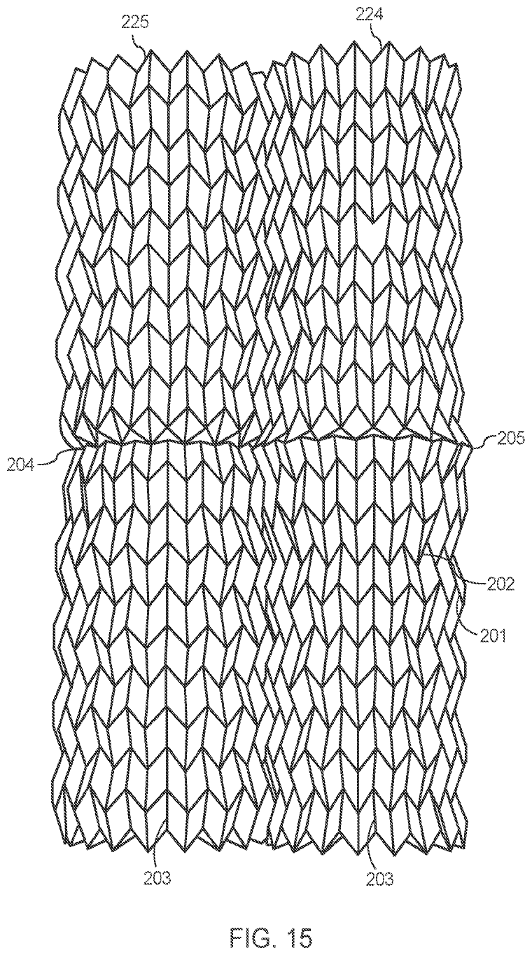

FIG. 15 shows another embodiment of a pair of rotary press roller dies 224 and 225. In this embodiment, roller die 225 comprises a forming surface with alternating zigzagging ridges 201 and valleys 202 wherein the pattern is interrupted by a straight valley 204 extending circumferentially around the roller die between two ridges 201. Roller die 224 is shaped complimentary to roller die 225 such that the forming surface has a straight ridge 205 extending circumferentially around the roller die between two zigzagging valleys 201 and interrupting the pattern of alternating zigzagging ridges 201 and valleys 202. The straight valley 204 of roller die 225 is axially aligned with the straight ridge 205 of roller die 224. When a sheet is pressed between the two roller dies, a packaging material is formed having a straight ridge between two zigzagging valleys (or a straight valley between two zigzagging ridges, depending on perspective). This ridge or valley can provide the packaging material with an extra degree of freedom to fold along the straight ridge or valley, allowing for more adaptability to different shapes. While FIG. 15 shows an embodiment where the pattern is interrupted by one straight valley along the center of the roller, in other embodiments, there may be more than one such interrupting straight valley or ridge. For example, there may be multiple straight ridges or valleys spaced equally or unequally along the width of the roller.

A process for forming the packaging material using the apparatus described herein is also disclosed. In one embodiment, the process comprises feeding the sheet of foldable material 170 from the supply roll 105, around the tensioning shaft 102, through a gap between top feed roller 123 and bottom feed roller 122, and over the cutting platform 136. The process then comprises operating motor 110 causing the pair of feed rollers 122 and 123 to feed the sheet 170 to the pair of rotary press roller dies 124 and 125. Through the operation of the same motor 110, the sheet 170 is fed through and pressed between the forming surfaces of the top and bottom roller dies 125 and 124 to form a tessellated sheet 171.

As the first edge of the tessellated sheet 171 passes through the pair of roller dies, the outfeed control arm(s) 162 are positioned in the downward position in which the arm(s) 162 block the sheet 171 from exiting the gap between the top and bottom outfeed rollers 149 and 141. While the first edge is blocked by the outfeed control arm(s) 162, motor 110 can be operated such that the feed rollers 122 and 123 and roller dies 124 and 125 feed more of the sheet 171 into the blocked portion. By feeding more of the sheet 171 into the blocked portion, the tessellated sheet 171 compresses by folding further along the fold lines and increasing the height of the sheet 171 until it makes contact with the top and bottom outfeed rollers 149 and 141.

After the tessellated sheet 171 makes contact with the outfeed rollers 141 and 149, the outfeed control arm(s) 162 are rotated outward to the upper position, clearing the gap between the outfeed rollers 141 and 149. The feed rollers 122 and 123 and roller dies 124 and 125 can continue to operate until the space between the roller dies 124 and 125 and the outfeed rollers 141 and 149 is filled with the compressed tessellated sheet 171. While the sheet 171 is being folded into the jam at the outfeed rollers 141 and 149, the outfeed guide rail 106 helps keep the sheet 171 in line. Once the space between the roller dies 124 and 125 and the outfeed rollers 141 and 149 is filled with the compressed sheet 171, the outfeed rollers 141 and 149 are rotated by the outfeed motor 140 and the first portion of the tessellated sheet 171 exits the apparatus 100.

The process can then continue by either stopping or slowing the rotation of the outfeed rollers 141 and 149. If the rollers are stopped, the process can continue by further operating the feed rollers 122 and 123 and roller dies 124 and 125 to compress more of the folded tessellated sheet 171 into the non-rotating outfeed rollers 141 and 149, which creates another jam. The outfeed rollers 141 and 149 can then rotate to eject more of the tessellated sheet 171 as the space between the roller dies 124 and 125 and the outfeed rollers 141 and 149 fills. Those steps can then be repeated continuously until either the supply roll 105 runs out of material or the sheet 170 is cut.

If the outfeed rollers 141 and 149 are slowed but not paused, the feed rollers 122 and 123 and roller dies 124 and 125 can be rotated at a speed faster than the outfeed rollers 141 and 149, which can also cause a similar jamming effect at the outfeed rollers 141 and 149 leading to compression of the tessellated sheet 171. As the compressed tessellated sheet 171 fills the space between the outfeed rollers 141 and 149 and the roller dies 124 and 125, the outfeed rollers 141 and 149 can be sped up in order to eject the compressed portion of the tessellated sheet 171. Those steps can then be repeated continuously until either the supply roll 105 runs out of material or the sheet 170 is cut.

If it is desired to cut the sheet 170, the feed rollers 122 and 123 can be stopped and the cutting motor 130 can be operated, causing the cutting mechanism 134 to slide across the cutting guide rail 137 and the blade 135 to move through the width of the sheet 170, cutting the sheet 170 against the cutting support rail 136 as it slides across. Once the sheet 170 is cut, the apparatus 100 can be operated as described above until the last end of the sheet 170 moves through the outfeed rollers 141 and 149 and is ejected from the apparatus 100. Then, the first edge of the next sheet 170 can be manually fed through the feed rollers 122 and 123 for the next cycle.

In some embodiments, the process further comprises perforating the sheet 170 across its width. This can be done by means known in the art after ejecting the tessellated sheet 171 from the apparatus 100. Alternatively, the roller dies 124 and 125 can comprise a perforating section comprising protrusions configured to punch a line of holes through the width of the sheet 170 as it passes though the roller dies 124 and 125. In some embodiments, the supply roll 105 contains a pre-perforated spirally wound sheet, such that no further perforations are needed.

It should be understood that the apparatus is not limited to the structure described herein and that the packaging material can be formed in any apparatus that includes a pair of rotary press dies with forming surfaces having the structure described herein. For example, while the apparatus described herein and illustrated by FIGS. 7-12 includes multiple drive belts and pulleys, it could also be designed using other types of gearing or actuation as well. Additionally, the components could be arranged in alternative configurations to achieve the desired result. The apparatus can be configured to be controlled manually or by automated control systems, which could optionally include pneumatic systems as well.

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1. An apparatus for making a tessellated packaging material, the apparatus comprising:
a frame;
a first axle attached to the frame;
a second axle parallel to the first axle and attached to the frame;
a first rotary press roller die disposed along the first axle, the first roller die comprising a forming surface having a plurality of ridges extending circumferentially along the forming surface and spaced axially from each other, every two adjacent ridges separated by a valley, each ridge having a ridgeline that zigzags in the circumferential direction alternating between a first angle α and a second angle β with respect to a plurality of longitudinal lines running parallel to an axis of the roller die, the longitudinal lines spaced circumferentially from each other, each valley having a valley line that zigzags generally parallel to the ridgelines in the circumferential direction such that the forming surface comprises a plurality of parallelogrammatic facets each having two vertices at angle α and two vertices at angle β; and
a second rotary press roller die disposed along the second axle, the second roller die having a forming surface complimentary to the forming surface of the first roller die, the first and second roller dies aligned such that a plurality of valleys on the second roller die intermesh with the ridges of the first rotary die,
wherein the first roller die is configured to rotate around its axis in a first direction and the second roller die is configured to rotate around its axis in the opposite direction.

2. (canceled)

3. The apparatus of claim 1, further comprising a first feed roller and a second feed roller, wherein the first feed roller is disposed along a third axle and is configured to rotate in the same direction as the first roller die and the second feed roller is disposed along a fourth axle and is configured to rotate in the same direction as the second roller die.

4. The apparatus of claim 3, wherein the second feed roller is coupled to the second roller die by a first drive belt, the first feed roller is coupled to the first roller die by a second drive belt, and the second roller die is coupled to a roller die drive motor via a third drive belt.

5. (canceled)

6. (canceled)

7. The apparatus of claim 4, further comprising a first reverse gear intermeshing with a gear attached to the second axle.

8. The apparatus of claim 7, wherein the first roller die is coupled to the reverse gear by a fourth drive belt, such that the first and second feed rollers and the first and second roller dies are all driven synchronously by the roller die drive motor.

9. The apparatus of claim 1, further comprising a cutting assembly attached to the frame, the cutting assembly configured to cut a sheet of packaging material upstream from the roller dies.

10. The apparatus of claim 9, wherein the cutting assembly comprises a guide rail attached to the frame, and a blade configured to move along the guide rail, the blade is a rotary blade configured to cut in a direction parallel to the first and second axles.

11. (canceled)

12. The apparatus of claim 10, further comprising a cutting assembly drive motor coupled to the cutting assembly by a fifth drive belt.

13. The apparatus of claim 1, further comprising a first outfeed roller disposed on a fifth axle and a second outfeed roller disposed on a sixth axle, wherein the first outfeed roller is configured to rotate in the same direction as the first roller die and the second outfeed roller is configured to rotate in the same direction as the second roller die, wherein the second outfeed roller is coupled to an outfeed motor by a sixth drive belt.

14. (canceled)

15. The apparatus of claim 13, further comprising a second reverse gear intermeshing with a gear attached to the sixth axle.

16. The apparatus of claim 15, wherein the first outfeed roller is attached to the second reverse gear by a seventh drive belt, such that the first and second outfeed rollers are driven synchronously by the outfeed motor.

17. The apparatus of claim 13, further comprising an outfeed control arm coupled to the frame by a shaft and configured to operate between a first position and a second position, wherein in the first position the outfeed control arm is configured to block a tessellated sheet from exiting an opening between the first and second outfeed rollers and wherein in the second position the outfeed control arm is configured to allow the tessellated sheet to exit the opening.

18. The apparatus of claim 17, further comprising an outfeed control arm motor coupled to the outfeed control arm and configured to move the outfeed control arm between the first and second positions.

19. (canceled)

20. The apparatus of claim 1, wherein one of the first or second roller dies has a straight ridge running in the circumferential direction between two of the zigzagging valleys and the other of the first or second roller dies has a straight valley running in the circumferential direction between two of the zigzagging ridges, wherein the straight ridge intermeshes with the straight valley.

21. (canceled)

22. The apparatus of claim 1, wherein angle α is from about 50 to about 85 degrees.

23. The apparatus of claim 1, wherein angle β is from about 95 to about 130 degrees.

24. The apparatus of claim 1, wherein each parallelogrammatic facet has two sides of length x and two sides of length y, length x measured along the zigzagging ridges between adjacent longitudinal lines and length y measured along the longitudinal lines between adjacent zigzagging ridges, and x is from about 1 cm to about 10 cm and y is from about 1 cm to about 10 cm.

25. The apparatus of claim 24, wherein the ratio of x to y is from about 0.3 to about 3.

26. A rotary press roller die for forming a tessellated packaging material, the roller die comprising a forming surface having a plurality of ridges extending circumferentially along the forming surface and spaced axially from each other, every two adjacent ridges separated by a valley, each ridge having a ridgeline that zigzags in the circumferential direction alternating between a first angle α and a second angle β with respect to a plurality of longitudinal lines running parallel to an axis of the roller die, the longitudinal lines spaced circumferentially from each other, each valley having a valley line that zigzags generally parallel to the ridgelines in the circumferential direction such that the forming surface comprises a plurality of parallelogrammatic facets each having two vertices at angle α and two vertices at angle β.

27-33. (canceled)

34. A process for making a packaging material, the process comprising feeding a sheet of creasable material between a first rotary press roller die and a second rotary press roller die to form a tessellated packaging material comprising a tessellated sheet comprising a plurality of parallel straight fold lines and a plurality of zigzagging fold lines extending across the plurality of straight fold lines, the zigzagging fold lines alternating directions at each straight fold line between an angle α and an angle β with respect to the straight fold lines such that the straight and zigzagging fold lines define a plurality of parallelograms each having two vertices at angle α and two vertices at angle β, each zigzagging fold line defining either a ridge or a valley, the ridges alternating with the valleys along each straight fold line.

35-57. (canceled)
